(19) United States
(12) Patent Application Publication
(10) Pub. No.: US 2015/0082686 A1
(43) Pub. Date: Mar. 26, 2015

(54) FISH CONTAINMENT DEVICE FOR ICE FISHING

(71) Applicant: Terry Merritt, Britton, MI (US)

(72) Inventor: Terry Merritt, Britton, MI (US)

(21) Appl. No.: 14/035,179

(22) Filed: Sep. 24, 2013

(51) Int. Cl. A01K 97/20; A01K 97/01

(52) U.S. Cl. CPC A01K 97/20; A01K 97/01
USPC 43/55

(57) ABSTRACT

A fish containment device for ice fishing comprising a tubular sleeve, where the tubular sleeve fits within an ice hole; a net attached to a bottom edge of the tubular sleeve, where the net houses one or more fish with water beneath the ice hole; and a plurality of tabs attached around a top edge of the tubular sleeve, where the plurality of tabs anchors the tubular sleeve to a top of edge the ice hole. With the fish containment device a user is able to store their fresh catch alive in the water until they are finished fishing.

### BACKGROUND OF THE INVENTION

1. Field of the Invention

The present invention relates to a storage container for fish while a person is ice fishing which maintains the fish in the cold water.

2. Description of Related Art

Ice fishing is a sport enjoyed both professionally and casually by many individuals. The practice enables a person to catch fish in a frozen body of water. The fishermen gain access to the fish by drilling a hole through the top layer of ice, through which they place their lines. Only the top surface of the water is frozen providing fresh water for the fish to survive. Sometimes the fisherman merely sits up on a stool or chair and is open to the surrounding elements. Alternatively, the fisherman may be within a shelter like a cabin which provides protection from extreme weather. Many cabins are equipped with heating elements, and some even include beds or bunks for the user's convenience.

While fishing the fisherman may place their fresh catch on the ice surface. This may be problematic after an extended period of time. Often the fish will freeze which may cause damage the quality of the meat. To preserve the fish after they are caught, it would be beneficial in the art to provide a device that maintains the fish in the freshest environment possible. It would also be desirable for the art to provide a fish container that is easily portable and compact for storage.

### SUMMARY OF THE INVENTION

In view of the foregoing disadvantages inherent in the prior art, the general purpose of the present invention is to provide a containment device for fish while ice fishing, configured to include all of the advantages of the prior art, and to overcome the drawbacks inherent therein.

Accordingly, an object of the present invention is to provide a fish containment device which includes a sleeve with a net, where the sleeve is positioned within an ice fishing hole to allow a user to place their fish in the net without risk of losing their fish.

Another object of the present invention is to provide a fish containment device where the sleeve includes tabs around the top to prevent the sleeve from falling into the water.

Yet another object of the present invention is to provide a net that is detachable from the sleeve for portability and compact storage when not in use.

To achieve the above objects, in an aspect of the present invention, a fish containment device is described comprising a tubular sleeve, where the tubular sleeve fits within an ice hole; a net attached to a bottom edge of the tubular sleeve, where the net houses one or more fish with water beneath the ice hole; and a plurality of tabs attached around a top edge of the tubular sleeve, where the plurality of tabs anchors the tubular sleeve to a top of edge the ice hole.

These together with other aspects of the present invention, along with the various features of novelty that characterize the present invention, are pointed out with particularity in the claims annexed hereto and form a part of this present invention. For a better understanding of the present invention, its operating advantages, and the specific objects attained by its uses, reference should be made to the accompanying drawings and descriptive matter in which there are illustrated exemplary embodiments of the present invention.

### BRIEF DESCRIPTION OF THE DRAWINGS

The advantages and features of the present invention will become better understood with reference to the following detailed description and claims taken in conjunction with the accompanying drawing in which:

FIG. 1 depicts a perspective view of a fish containment device for ice fishing in accordance with an exemplary embodiment of the present invention.

### DETAILED DESCRIPTION OF THE DRAWINGS

The present invention relates to a storage container for fish while a person is ice fishing which maintains the fish in the cold water. The present invention provides a fish containment device for ice fishing to keep the fish alive for longer periods of time while out in the elements. The fish containment device provides a sleeve with a net fastened to the bottom edge. The sleeve rests within a hole in the ice allowing the net to be securely suspended in the water. By keeping the fish in the water they stay alive thus providing the freshest tasting meat.

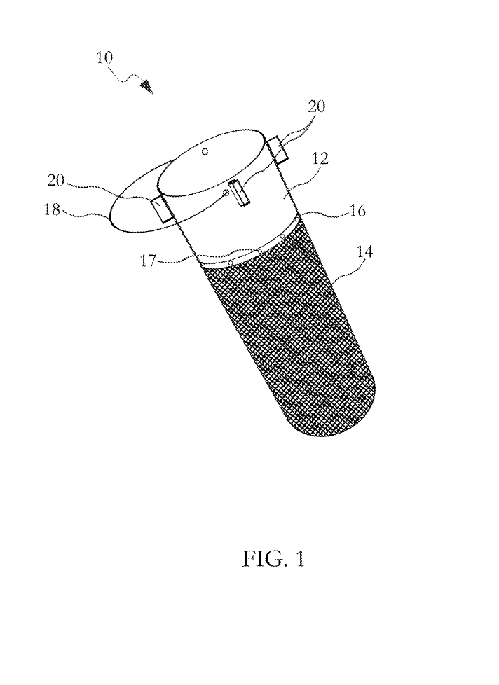

Turning now descriptively to the drawings, referring to FIG. 1, a fish containment device 10 for ice fishing is shown in accordance with an exemplary embodiment of the present invention. The fish containment device 10 includes a tubular sleeve 12 to comprise the upper portion of the device 10. The tubular sleeve 12 may be made from plastic or aluminum to be lightweight and portable. The dimensions of the tubular sleeve 12 may range from 6-12 inches in diameter, and 6-12 inches in height. Preferably, the diameter is 7 inches and the height is 6 inches.

The tubular sleeve 12 includes a bottom edge 16 to which a net 14 is fastened. The net may be removably fastened to the bottom edge 16 with a fastening means 17. The fastening means 17 may be a hook and loop fastener (commonly known as Velcro®), or a plurality of snaps or hooks. By detaching the net 14 from the tubular sleeve 12, the fish containment device 10 is easily portable and convenient for storage. Also, detachment allows the user to replace the net 14 if it is ever damaged or a larger net 14 is necessitated. The net 14 hangs freely beneath the tubular sleeve 12 approximately 12-36 inches. When the tubular sleeve 12 is positioned within an ice hole the net 14 hangs in the underlying water ready to receive one or more fish. This way they may easily move within the bag, but are still held securely for as long as desired by the fisherman.

At a top portion of the tubular sleeve 12 is a handle 18. The handle 18 enables the user to easily lift and carry the fish containment device 10 during use. Around the top peripheral edge of the tubular sleeve 12 are a plurality of vertical tabs 20. The vertical tabs 20 serve as anchors to prevent the tubular sleeve 12 from sliding into or around the ice hole. Additionally, the vertical tabs 20 allow the user to more easily lift the tubular sleeve 12 from the ice after use. With the fish containment device 10 for ice fishing the user is afforded peace of mind that their catch is kept fresh while they continue to fish.

The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The exemplary embodiment was chosen and described in order to best explain the principles of the invention and its practical application, to thereby enable others skilled in the art to best utilize the invention and various embodiments with various modifications as are suited to the particular use contemplated.

What is claimed is:

1. A fish containment device for ice fishing comprising:
a. a tubular sleeve, where the tubular sleeve fits within an ice hole;
b. a net attached to a bottom edge of the tubular sleeve, where the net houses one or more fish within the water beneath the ice hole; and
c. a plurality of tabs attached around a top edge of the tubular sleeve, where the plurality of tabs anchors the tubular sleeve to a top of edge the ice hole.

2. The fish containment device according to claim 1, where the net is removably attached to the bottom edge of the tubular sleeve with a fastening means.

3. The fish containment device according to claim 2, where the fastening means is one of at least a hook and loop fastener, a plurality of snaps or a plurality of hooks.

4. The fish containment device according to claim 1, where the plurality of tabs are positioned vertically.

5. The fish containment device according to claim 1, where the tubular sleeve includes a handle attached to a top edge.

6. The fish containment device according to claim 1, where the tubular sleeve is aluminum.

7. The fish containment device according to claim 1, where the tubular sleeve is plastic.

8. The fish containment device according to claim 1, where the net extends beyond the tubular sleeve 24 inches.

9. The fish containment device according to claim 1, where the tubular sleeve measures 7 inches in diameter and 6 inches in height.
